(19) United States
(12) Patent Application Publication
(10) Pub. No.: US 2007/0066334 A1
(43) Pub. Date: Mar. 22, 2007

(54) Locating system utilising adjustable transmission power in a micro-cellular network

(75) Inventors: Michael Stewart Butts, Balgowlah, NSW (AU); Amir Said Khoskbijary, Trinity Beach, QLD (AU); Michael John McCann, Narrabundah, ACT (AU)

Correspondence Address: BROOKS KUSHMAN P.C., 1000 TOWN CENTER, TWENTY-SECOND FLOOR, SOUTHFIELD, MI, 48075, US

(73) Assignee: ICT SYSTEMS PTY LTD, Manuka, ACT (AU)

(21) Appl. No.: 10/595,175

(22) PCT Filed: Sep. 17, 2004
(86) PCT No.: PCT/AU04/01273

§ 371 Date: Mar. 17, 2006

(30) Foreign Application Priority Data
Sep. 17, 2003 (AU) 2003905066

(51) Int. Cl. H04Q 7/20; H04B 7/00

(52) U.S. Cl. 455/522; 455/443

(57) ABSTRACT

A communications system and a method of wireless communication for mobile units (MU) within a facility having a central controller (FP server), a plurality of wireless base stations (BS1-BS11) having an adjustable transmission power. The base stations are distributed throughout the facility for wireless communication with the controller and the mobile units (MU). The controller (FP server) configures the base stations (BS1-BS11) into a plurality of micro-cells (MC1-MC6) each including at least two base stations (BS1-BS11) by adjusting the wireless transmission power of the base stations (BS1-BS11) such that at least one base station (BS1-BS11) in each micro-cell (MC1-MC6) is a member of another micro-cell (MC1-MC6). At least one base station is able to communicate with the central controller (FP server) and all mobile units (MU) within a selected area of the facility are able to communicate with at least one base station (BS1-BS11).

### FIELD OF THE INVENTION

The present invention relates to a communications system for mobile units within a facility. The invention has particular application to location and messaging systems. Although the invention will be described in relation to its application to a passenger terminal facility such as an airport, it is equally applicable to a range of other facilities where the location of a person or object is required or where messaging to the person or object is necessary. For example, the invention is applicable to hospital facilities where monitoring of medical staff and patients location and the selective dissemination of messages to staff can significantly improve efficiency.

### BACKGROUND

Location systems for locating a person or object within a facility are known. Often these operate by a person carrying around an identification transponder which sends a signal or signals to a set of receivers which in turn send a signal to a central processing unit. Usually the signal from the transponder to the receivers is an identification signal and the signal from the receivers to the central processing unit includes the identification signal from the transponder and signal strength. The central processing unit is then able to determine the location of the transponder, and consequently the person in the facility.

Messaging systems are known such as Short Messaging Service and Paging Services. These often send messages from a base station to a receiver which displays or otherwise communicates a message.

A system that includes both a messaging and location system is known from U.S. Pat. No. 5,543,797. A monitoring assembly and system monitors the location of mobile objects within a structure. The assembly includes a plurality of transponder means, transceivers located in spaced areas about the monitored structure and a central controller that monitors the location of each transponder. The transponder transmits a signal in response to a signal, containing the transponder's ID, from a transceiver. Each transceiver is connected to the controller in parallel and sends the signal containing the transponder's ID and all transceivers are able to receive the signal from the transponder. The transceivers collect signal strength and other data and forward this to the central controller. The controller stores the values in a memory so that the location of the transponder is known. The transponder includes audio means for audibly communicating with the person.

For large systems, for example in a multi story building, large amounts of cabling is required to connect the central computer to the receivers. One solution is to send the signal from the receivers to the central computer wirelessly, however in large applications the power required to transmit the signal is large and may be unsafe. Additionally, a relatively large amount of bandwidth can be required to communicate simultaneously with a large number of receivers

It is therefore desirable to provide a location and/or messaging system in which the signals are wirelessly transmitted whilst being transmitted at relatively low power levels.

### DISCLOSURE OF THE INVENTION

Accordingly, in one aspect the present invention provides a communications system for mobile units within a facility comprising a central controller, a plurality of wireless base stations having an adjustable transmission power, said base stations being distributed throughout the facility for wireless communication with said controller and said mobile units, said controller configuring said base stations into a plurality of micro-cells each including at least two base stations by adjusting the wireless transmission power of said base stations such that at least one base station in each micro-cell is a member of another micro-cell, at least one base station is able to communicate with the central controller and all mobile units within a selected area of the facility are able to communicate with at least one base station.

In a second aspect the present invention provides a method of wireless communication between a central controller and mobile units within a facility via a plurality of base stations having adjustable transmission power distributed throughout the facility for wireless communication with said controller and said mobile units comprising configuring the base stations into a plurality of micro-cells each including at least two base stations by adjusting the wireless transmission power of said base stations such that at least one base station in each micro-cell is a member of another micro-cell, at least one base station is able to communicate with the central controller and all mobile units within a selected area of the facility are able to communicate with at least one base station.

Preferably each micro-cell includes at least two base stations that are members of other micro-cells.

Preferably, the micro-cells include between two and six base stations. The base stations preferably transmit periodically a message including its unique identification number and its transmitting power. Each base station preferably maintains a list of signals received from other base stations and the signal strength, expressed as a fraction of the transmission power, which is also transmitted with the unique identification number and transmitting power. The base station transmission power is preferably altered such that there is minimal overlap of base stations between micro-cells.

According to the invention messages are transmitted over the communication system by a base station transmitting the message to all base stations within a micro-cell to which it belongs, and at least one other base station within the micro-cell transmitting the message to the base stations within another micro-cell to which the other base station belongs.

In one form of the invention the communication system is for locating and messaging to mobile units in a facility. The base stations preferably each have a known location and the micro-cells which are small systems of base stations are within a relatively small area, when compared to the facility.

The mobile units preferably include a transceiver for receiving and sending signals, a display device for displaying messages, a power source and at least one user interface for accepting an input from a person.

The central controller preferably includes a database of locations of the base stations and a database of which base stations have received a reply signal from the mobile units.

For convenience the application has coined the generic term Local Area Wireless Security (LAWS) system to describe the technology of the invention.

The invention will now be described in relation to locating passengers in an airport passenger terminal facility and providing messages with reference to the accompanying drawings.

### BRIEF DESCRIPTION OF THE DRAWINGS

FIG. 1 is a schematic flow chart showing the steps, information flow and some of the components used between booking a ticket and check-in for an airline passenger departing from an airport utilising the communication system according to this invention;

FIG. 2 is a flow chart similar to FIG. 1 showing the steps, information flow and some of the components used between check-in and boarding of an aircraft; and

FIG. 3 is a schematic drawing of base stations and area of coverage in a facility using the communication system according to this invention.

### BEST MODES FOR CARRYING OUT THE INVENTION

System Overview

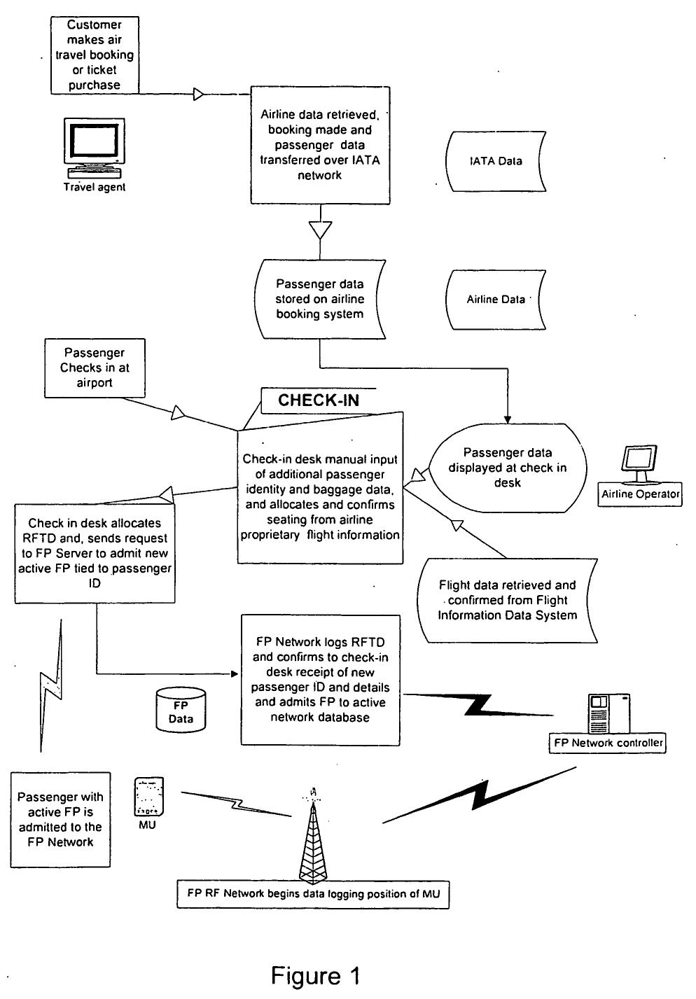

The communication system of this invention in its application to an airport passenger facility involves the use of radio frequency tracking device or mobile unit (MU) that is issued to each passenger when they check in to a scheduled flight departing from that airport. Each MU issued uniquely identifies the associated passenger. The communication system of this invention allows the location of an MU to be tracked throughout the terminal facility and allows messages relevant to flight details to be passed to the MU for the information of the passenger. FIG. 1 is a schematic flow chart showing the steps involved and information flow between the time a passenger makes an air travel booking or purchases a ticket and subsequently arrives at the airport. The first part of the flow chart shows the standard steps involved in a passenger making a booking or purchasing a ticket. The passenger makes a booking and the airline data is retrieved by a travel agent or sales representative and transmitted over the existing International Aviation Transport Association (IATA) networks to the airline booking system. Check-in procedure at an airport proceeds in the normal way using the airline's existing facilities. The passenger data is displayed at the airline operator's terminal and verified with the passenger. The airline computer system will have previously been updated with flight data retrieved and confirmed from flight information databases in the known manner.

At check-in the passenger identity is confirmed and the usual baggage data recorded and seat allocation steps proceed. This information is downloaded through an interface of known type to both the MU that will be issued to the passenger and to the communication system server (FP Server). The transfer of the data from the airline computer activates the MU that is given to the passenger and sends a request to the FP server to admit a new passenger identification corresponding to the MU to the system. The FP server operates through a network control which communicates with the MU via the system.

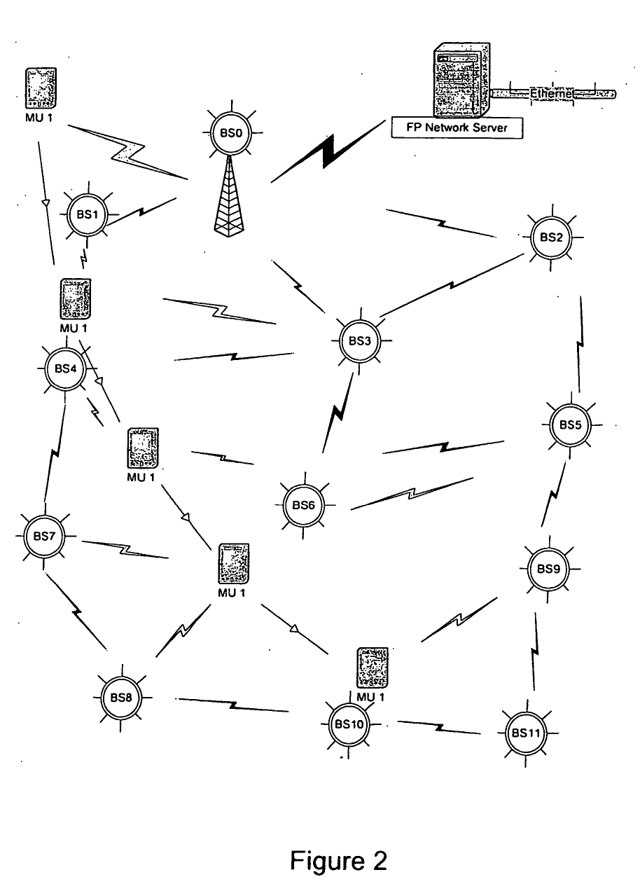

FIG. 2 schematically shows the path of an MU designated MU 1 through the communication system from check-in to a boarding gate where the MU is returned. The MU units are re-chargeable battery powered transceiver with onboard memory, RFID chip, LCD display, an infra red port covering IR transmit and receive diodes, a user interface in the form of a button to scroll through messages and data displayed. When not in use the MU is stored and transported in a secure transport case enclosing a number of cradles for MUs. When placed in these cradles the MU battery is inductively recharged and the IR port is enabled as a data connection and for diagnostic processes. A number of light emitting diodes can be provided for diagnostic and communication purposes. The communication system is made up of a series of base stations numbered in FIG. 2 as BS0 to BS11. The operation of the individual parts of system will be described in greater detail below. In overview each base station is a low power limited range transceiver. Each base station is only able to transmit or receive from closely adjacent base stations. This creates a system of smaller overlapping networks or micro-cells. At least one of the base stations is in communication with the FP server which logs all the information received from at least one of the base stations.

The base stations regularly transmit their identity and other information. The MU devices always receive but only transmit when they first “hear” a particular base station or when they cease to hear a particular base station. These reports are transmitted to the system server in the manner described below.

Should an MU move outside the range of the system, for example by leaving the airport, a perimeter alert will be sent to the system server from the perimeter base station. The time and place at which the MU left the system will be communicated to the airline on which the passenger was scheduled to travel.

It will be apparent that through this system appropriate messages can be provided to a passenger via the MU. For example messages about delayed flights can be transmitted or instructions to urgently proceed to the gate issued. Additionally, the system can issue messages that guide a passenger to a destination by providing reference to physical features in the building and signage.

The airline staff can access the FP server to identify all MU's issued in relation to a particular flight. This enables the messages to be sent by airline staff to individual passengers or groups of passengers. The FP server is also able to provide a display of the floor plan of the airport showing location of MU's issued on a particular flight. Various menus are provided for calling flights and sending messages to passengers and identifying distances and estimates of time passengers are from a particular point. If a passenger fails to board an aircraft their location can be determined and appropriate action taken.

At the boarding gate the MU is returned to airline staff and its return is logged to the FP server.

The detailed operation of the communication system and operation of the base stations and mobile MU units is described below.

Base Stations

All base stations are identical in construction and run identical software, save for a unique ID encoded within the software.

Base stations are deployed in enclosed spaces (rooms) to provide wireless coverage of the whole area of operation in the facility. The precise location of the (physically static) base station is known at the time of deployment in terms of an Easting/Northing coordinate pair (this is derived from a site plan of the installation in terms of some X/Y metric grid).

Given the complex topology within which base stations are deployed in any given application, the characteristics of Radio Frequency transmission and performance cannot be predicted with any level of certainty in advance of deployment. However, experiments confirm a high level of RF transparency within and between enclosed spaces, within a typical operating environment.

Base stations have a maximum transmitting range of approximately 50-100 metres depending on the physical layout of the environment. Variations in transmitting range are evident from unit-to-unit (because of minor variations in the manufacture of electrical components) and at different times of the day (because of atmospheric and electromagnetic variations.

The power with which a base station transmits (and hence the range of that transmission) can be dynamically varied under software control. The base stations are also able to make a measurement of received signal strength from either another base station or mobile unit (MU).

The devices have a relatively low bandwith (72,000 bits/sec). This allows short message transactions with minimal protocol overhead in order to operate efficiently a synchronised set of base stations in a system, to enable maximum information flow.

Base stations operate in localised groups which can communicate with each other—“micro-cells”. The micro-cells are managed logically by a software protocol, rather than be haphazard. The formation of managed micro cells allows an assumption that the environmental factors are constant within a micro-cell and because the total population of base stations is partitioned into small largely independent networks, bandwidth constraint only applies to each local network individually. The micro-cell provides the basis for locating mobile units which enter and leave micro-cells.

Base stations are controlled to form a set of overlapping micro-cells, so that information can be relayed across the entire network in a series of “hops”. A micro cell will be of the order of 2-6 base stations which can communicate with each other; the size of a micro-cell will depend on the physical topology of the area in which they are located. A minority of the micro-cell members will be able to communicate with base stations belonging to adjacent micro-cells. The micro-cells will be managed so as to ensure, but minimise, the extent of overlap, thereby ensuring the micro-cell is as localized as possible. Those base stations which straddle more than one micro-cell provide the bandwidth constraint and determine the total information flow possible through the entire network. At least one micro-cell (and possibly several) are able to communicate with a central host server, thus central communication and control is achieved.

Micro-cell configuration is not pre-determined; base stations will be deployed to reflect the physical layout of rooms and buildings (eg 1 per room, or 2 or more in larger open spaces). Base stations will then negotiate with each other to form micro-cells. The negotiation will be continuous during operation because of dynamically changing transmitting characteristics.

A software protocol drives base stations, and governs the formation of micro-cells. Each base station periodically (every few seconds) transmits a message containing its unique ID, together with the transmission strength of that message. Each base station maintains a list of the other base stations it can “hear”.

When each base station transmits its unique ID it also transmits the list of base stations it can hear. Thus each base station can dynamically determine the membership of its local micro-cell.

Initially, on power-up, base stations transmit at minimum power (range), gradually increasing. As messages are received from adjacent base stations, each base station reduces its power until the characteristics of local micro-cells meet the required operation (of minimal overlap). From then on, power will be varied to maintain the required micro-cell characteristics.

Micro-cells do not necessarily have fixed membership. Transient changes may be expected because of varying operating conditions. Also, the overall pattern will be self-healing in that a “hole” created by the hardware failure of an individual base station can be dynamically accommodated.

Mobile Units (MU)

The MUs are rechargeable battery powered transceivers with a unique ID. The ID of each mobile unit is recorded on the system server against the passenger name, flight details and other information at the time of issue of the mobile unit. The MU includes onboard memory and a processor to run software associated with its operation. The MU detects base station transmissions and determines whether it has previously heard that base station within a determined previous time interval.

Mobile units will enter and leave micro-cells. The mobile unit will hear the base stations transmission declaring its ID as part of the micro-cell management cycle. The mobile unit will maintain a list of “visible” base stations, together with their transmission strength(TS) and received signal strength(RSS). When the mobile unit detects it has heard a new base station, or lost a previously visible base station, or observed a significant change in the TS/RSS relationship for that particular base station, it will inform a visible base station of that event by passing a message with the unique ID of the base station which generated the event, as well as its relevant TS and RSS. The base station will “ripple” (see separate note on Ripple Protocol) that message across micro-cells to the host server. The location of micro-cells allows the central server to estimate the physical location of the mobile unit, as it maintains a current list of those base stations visible to each mobile unit, together with their estimated distance to the mobile unit.

In order to determine whether there has been a significant change in the TS/RSS relationship, and hence a change in position, the mobile unit calculates an on-going long term moving weighted average (LTMWA), and short term moving weighted average (STMWA), of TS/RSS for each base station. The purpose of calculating moving weighted averages is to smooth any temporary or random fluctuations in signal. If the STMWA differs from the LTMWA by more than a critical amount, then a change of location is deemed to have taken place; the change is reported and the new value of LTMWA is set to the value for the current STMWA, before the on-going calculations continue. The number of entries contributing to the STMWA, and what constitutes a critical change, are determined by experimental observation.

Distance Determination

Empirical studies of the devices operating in a range of typical environments (for example, outdoors, indoors, indoors in closed spaces) allow the tabulation of received signal strength against the distance between units, for different transmitting signal strengths. Thus, when a unit receives a signal from another unit, transmitted at a known strength, distance from that unit based on the received signal strength of that message can be estimated. The relationship between ESS, transmitted signal strength, received signal strength and distance apart is entirely empirical based on the actual electronic performance of the developed devices. The FP server can estimate by simple triangulation the location of a mobile unit, by reference to each base stations location (Easting/Northing) and its estimated distance from the mobile unit.

Ripple Protocol for Relaying Messages Across the System

As described above the base stations will configure themselves into a set of managed interconnected “micro-cells”, a configuration which may dynamically change in response to operating conditions.

In the system, the majority of base stations are out of range of the FP server. The FP server holds all central data on flights/passengers, and is the interface between client users at check-in and departure applications, and the system and mobile population.

In order to conserve bandwidth and operate at relatively low transmission power, the messages are not transmitted individually to each base station in turn—since any base station within a micro-cell will receive any message transmitted by any other member of its micro-cell, by definition. Rather the message is transmitted across the interconnecting set of micro-cells, to its destination, with the minimum number of re-transmissions (hops).

The progress of a message being relayed across the system may be pictured as the waves of a ripple progressing across a pond. Each base station maintains a list of “visible” base stations that form the local “micro-cell”. Appended to each ID of the ‘visible’ members of the micro-cell is a list all other base stations which that ID can see. Thus in the configeration shown in FIG. 2, BS0 can see 1, and 3. BS3 can see 0, 1, 2, 4, 5 and 6. BS1's record of the ID of BS3 notes that 3 can also see 2, 4, 5 and 6.

When a message is received by a member of the micro-cell, that member determines which other members of its micro-cell will have received that message (those which overlap with the sending base station). Thus, the receiving base station can deduce which other base station is the best candidate to relay a message to an adjacent micro-cell. When relaying the message to the chosen base station, all members of the current micro-cell receive the message as well and similar determinations about re-transmission are made.

If the message is being addressed to an individual base station which is a member of the current micro-cell, intended for a local MU, then the message is simply sent to that specific base station, rather than relayed. If a message is being broadcast to all MUs (eg for all passengers on a particular flight) then the receiving base station, by relaying the message on to an adjacent micro-cell, automatically ensures that all base stations (and adjacent MUs) within the micro-cell will have received that message.

Thus when the host server wishes to transmit a message to a remote MU, it is necessary only to transmit the message to the base station “closest” to the FP server which will then begin the process of relaying the message. The message will be relayed to the base station nearest the MU, since if that base station hears the message, so will the MU. When a MU wishes to send a message to the FP server then it simply has to send that message to its nearest base station, which then relays the message across the system, eventually to the FP server.

Thus, messages are not sent to MU's directly, rather the population of base stations all receive the message, and therefore any MU within the system defined by the base station population receive the message. The logic within the software of the individual MU determines what action, if any, an individual MU will take to any given message.

Some base stations will have direct ethernet connectivity (connected via cable or by wireless ethernet) to the host server. In the case of these base stations, they will not relay messages—rather they will send the message directly to the host server, and receive a message directly from the host server. The presence/absence of direct ethernet connectivity will depend on the scale and the physical environment within which any given application is deployed.

Message Structure

It is necessary to transmit messages of minimal length to make best use of the available bandwith; thus to ensure maximum information flow through the system each message should carry the minimal protocol overhead necessary to enable its transmission and delivery. Also, to be able to control the usage of bandwidth effectively, the protocol design should ensure that the many mobile units send the minimum of unsolicited messages to avoid uncontrolled peaks in bandwidth usage.

The following terms are defined:

Message Type (1 character) the type of the message (see below)

Sender ID (4 [8-bit] characters—all devices will have a unique 32 bit ID generated at manufacture—approx 4 billion permutations);

Initiator ID (4 characters) the device creating the message

Addressee ID (6 characters)—an individual MU or a flight number.

Desination Base ID (4 characters)—a base station nearest to the MU for which a message is intended.

Message Number (1 character) a sequential count 0-15 maintained individually by each mobile unit; the count is increased for each successive message that the unit initiates—see below.

Hop Count (1 character)—see below. NB not required for A messages.

The hop count is the number of times a message is relayed before it expires. This ensures that a message will not continue circulating indefinitely. The value of hop count will be determined empirically when the initial system is deployed. Larger systems of base stations will require larger values, since a message must be relayed through more micro-cells to reach one end of the system from another. Each time the message is relayed the hop count is decreased until it reaches zero at which point no further relay is undertaken.

In addition, each base station will maintain a transient list of initiator IDS and message number of received messages. If a received message matches an entry on the list then it is not relayed. This list will not cover all possible MUs, since its purpose is only to monitor messages currently “live”. This, plus the hop count above, will ensure the minimum number of re-transmissions.

Protocol—Message Content

The message vocabulary consists of the following:

A - Ping From A Base Station
All base stations periodically output a ping

| Field | Chars | Comment |
|---|---|---|
| Message Type | 1 | “A” |
| Sender ID | 4 | |
| Transmission Strength | 1 | 1-244 |

Ping messages are not relayed beyond the immediate micro-cell.

B - Mobile Tells Base Station About Change To Bases
Only sent when the mobile detects a change to its visible set.

| Field | Chars | Comment |
|---|---|---|
| Message Type | 1 | “B” |
| Sender ID | 4 | The MU or base relaying this message |
| Hop Count | 1 | |
| Message number | 1 | |
| Initiator ID | 4 | |
| Base Station TSSI | 1 | 1-31 |
| Base Station RSSI | 1 | 0-244, 254 = deletion |
| Base Station ID | 4 | |

Base station details are repeated for all the Mobiles current visible bases.

The mobile units may be programmed to report when ESS changes by some critical value, to assist in tracking the mobile. Further it may be desirable to be able to set the critical reporting values dynamically by a message from the host server to a MU, so as to enable more frequent reporting from one or more mobiles under scrutiny. The host server will have a variety of other queries to the population of mobile units that will interrogate sets of the mobile population or individual units to change mobile behavior extract information from them.

C - Message For Mobile LCD
Initiated by the client/host server (PC applications), relayed
across the system as required.

| Field | Chars | Comment |
|---|---|---|
| Message Type | 1 | “C” |
| Sender ID | 4 | |
| Hop Count | 1 | |
| Message number | 1 | |
| Destination Base ID | 4 | =“0000” for broadcast |
| Addressee ID | 6 | |
| Display Type | 1 | =1 for free text |
| | | =2 for msg type 2 . . . etc |
| Message | N | For free text msg only |

D - Set Passenger Details

| Field | Chars | Type |
|---|---|---|
| Message Type | 1 | “D” |
| Sender ID | 4 | |
| Hop Count | 1 | |
| Message number | 1 | |
| Addressee ID | 4 | Mobile ID |
| Flight | 6 | |
| Flight Time | 4 | Format 0930 |
| Gate | 4 | |
| Baggage | 1 | Number of bags - but could be |
| | | extended to baggage ID and |
| | | type of accompanying luggage |
| Last Name | N | |

Note that a D message is sent at check in when the mobile unit is under immediate control; this message need not be rippled across the system. This depends on the configuration of the Power Box for the mobile units.

Once the details are stored in the mobile unit, the user may view the details through a simple key driven menu on the local MU—this has no impact on system traffic.

E - Set Flight Time and Gate

| Field | Chars | Type |
|---|---|---|
| Message Type | 1 | “E” |
| Sender ID | 4 | |
| Hop Count | 1 | |
| Message number | 1 | |
| Destination Base ID | 4 | =“0000” for broadcast |
| Addressee ID | 6 | |
| Flight Time | 4 | Format 0930 |
| Gate | 4 | |

Used to update flight information.

F - Set Operating Parameters in Mobile

| Field | Chars | Type |
|---|---|---|
| Message Type | 1 | “E” |
| Sender ID | 4 | |
| Hop Count | 1 | |
| Message number | 1 | |
| Destination Base ID | 4 | =“0000” for broadcast |
| Addressee ID | 6 | |
| Value | 2 | Bit pattern |

Whilst it is desirable to keep the vocabulary of messages to the minimum, additional message type will undoubtedly be added to enhance functionality. The above list represents the minimum for a functioning tracking and messaging system.

G - Wifi Bases Send Details
This allows other units to maintain a list of local units
in wifi range.

| Field | Chars | Comment |
|---|---|---|
| Message Type | 1 | “G” |
| Sender ID | 4 | |
| Transmission Strength | 1 | 1-244 |
| Bases in View | 4* bases | |

Base station data repeated in the packet according to the number visible. This message is not relayed beyond the immediate micro-cell.

H - RF Bases Send Details
This allows other units to maintain a list of local units
in RF range.

| Field | Chars | Comment |
|---|---|---|
| Message Type | 1 | “H” |
| Sender ID | 4 | |
| Transmission Strength | 1 | 1-244 |
| Bases in View | 4* bases | |

Base station data repeated in the packet according to the number visible. This message is not relayed beyond the immediate micro-cell.

Operation

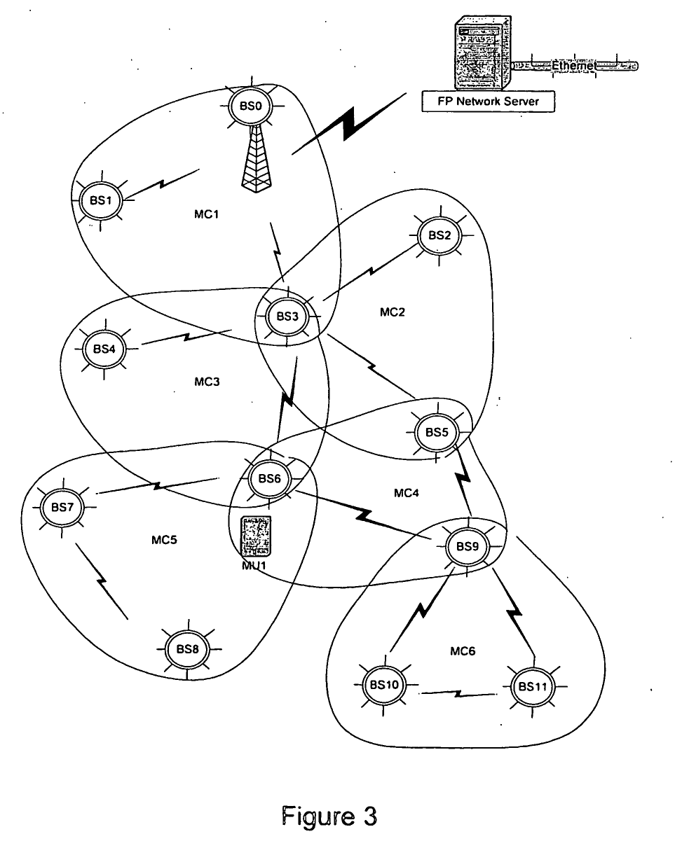

Referring to FIG. 3, the communication system and related location and messaging systems are formed around the main concept of having a plurality of micro-cells which are linked together with the minimum amount of overlap. This can be achieved by only having one base station within a first micro-cell being also in a second micro-cell. This means that there are no multiple connections between micro-cells. The base stations 1-10 are located throughout the facility and have adjustable power levels. The micro-cells MC1, MC2, MC3, MC4, MC5 and MC6 are formed to enable quick communication throughout the system.

For example, if a message was to be sent to base station 10 in MC6 from base station 0, base station 0 would transmit the message to its micro-cell 1 (MC1). Base station 3 would then transmit the message to its other micro-cells MC2 and MC3.

Base Station 6, a member of MC3, MC4 and MC5 then ripples the message to all base stations in MC4 and MC5. At this stage only base stations 10 and 11 have not received the message. Base station 9, a member of MC4 and MC6 would then transmit the message to the other members of MC6 including base station 10.

The system of base stations will configure themselves into set of a managed interconnected micro-cells under software control, which can dynamically change in response to operating conditions.

In one embodiment of the invention, the communication system is enabled by a software protocol in the base stations, which in turn governs the formation of micro-cells. Each base station will periodically, every few seconds, transmit a message containing its unique ID and its transmitting power. Each base station will maintain a list of the other base stations it can “hear”, together with the signal strength observed from those base stations. This is expressed as a fraction of the transmission power, eg base station A transmits at 75%, base station B receives the signal at 50%, thus Effective Signal Strength (ESS) is 0.5/0.75=0.66.

When each base station transmits its unique ID it will also transmit the list of base stations it can see. Thus, each base station can dynamically estimate the membership of its local micro-cell, as well as the extent of overlap with adjacent micro-cells. Thus, if a base station can see another base station, which in turn can see a third base station which is “invisible” to the first base station, then the first base station knows there is an adjacent micro-cell of which the third base station is a member. This knowledge is essential to the “ripple protocol”: if a base station receives a message from another base station and both base stations can see the same set of base stations, then there is no need to further propagate that message. However, if the receiving base station can see base stations not seen by the first sender, then the message must be relayed.

Initially, at power-up, base stations will transmit at minimum power, gradually increasing. As messages are received, from adjacent base stations, each base station will reduce its power until the characteristics of local micro-cells meet the required operation of minimal overlap. From then on, power will be varied to maintain the required micro-cell characteristics.

In this embodiment micro-cells will not necessarily have fixed membership. Transient changes may be expected because of varying operating conditions such as humidity and the amount of absorption of the signal by the environmental changes. The overall coverage of the system will be self-correcting, in that holes created by failure of hardware can be dynamically accommodated for.

In the system, most base stations are likely to be to be remote from, or out of range, of the central controller. The central controller holds all central data on flights/passengers and is the interface between client users at check-in and departure applications, the communication system and mobile units. It will be necessary to receive and transmit messages to and from the remote base stations.

A message is conveyed across the system by each micro-cell sending the message to adjacent micro-cells, causing a ripple effect. As each base station in the micro-cell receives the message when transmitted, the message is retransmitted as shown in FIG. 3.

In operation as a locating and messaging system, MUs will enter and leave micro-cells. The MU will hear the base stations transmission declaring its ID as part of the micro-cell management cycle. The MU will maintain a list of ‘visible’ base stations. When the MU detects it has heard a new base station, or lost a previously visible base station, it will inform a visible base station of that event by passing a message with the unique ID of the base station (and its estimated distance—zero in the case of a lost base station) which generated the event. The base station will send this message to the central controller (FP server). The location of the micro-cells allows a central server to estimate the physical location of the MU, together with the estimated distance to the MU.

At any time, the central controller (FP server) knows for any given MU which base stations are visible and their estimated distance from the MU. Thus the central controller (FP server) can estimate by simple triangulation the location of a MU, by reference to each base station location and its estimated distance from the MU.

The majority of base stations are likely to be out of range of the host server (FP server)—ie ‘remote’. The host server holds all central data on flights/passengers, and is the interface between client users at check-in and departure applications, and the system and MU. It will be necessary for the host server to transmit messages to, and receive messages from, the ‘remote’ base stations.

To conserve bandwidth, the message need not be transmitted individually to each base station in turn—since any base station within a micro-cell will receive any message transmitted by any other member of its micro-cell. The message is conveyed across the interconnecting set of micro-cells, to its destination, with the minimum number of re-transmissions (hops).

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgement or any form of suggestion that that prior art forms part of the common general knowledge in Australia.

1. A communications system for mobile units within a facility comprising a central controller, a plurality of wireless base stations having an adjustable transmission power, said base stations being distributed throughout the facility for wireless communication with said controller and said mobile units, said controller configuring said base stations into a plurality of micro-cells each including at least two base stations by adjusting the wireless transmission power of said base stations such that at least one base station in each micro-cell is a member of another micro-cell, at least one base station is able to communicate with the central controller and all mobile units within a selected area of the facility are able to communicate with at least one base station.

2. A communications system as claimed in claim 1 wherein each micro-cell includes at least two base stations that are members of other micro-cells.

3. A communication system as claimed in claim 2 wherein each micro-cell includes from three to six base stations.

4. A communication system as claimed in claim 1 wherein the base stations periodically transmit a message including a unique identification code.

5. A communication system as claimed in claim 4 wherein said message includes a measure of the transmitting power of the base station.

6. A communication system as claimed in claim 1 wherein each base station maintains a list of signals received from other base stations.

7. A communication system as claimed in claim 1 to 6 wherein the base station transmission power is adjusted to provide minimal overlap of base stations between micro-cells.

8. A communication system as claimed in claim 1 wherein the base stations each have a known location and the micro-cells have a relatively small area compared to selected area of the facility.

9. A locating and messaging system for mobile units in a facility including a communication system as claimed in claim 1.

10. A location and messaging system as claimed in claim 9 wherein the mobile units include a transceiver for receiving and sending signals, a display device for displaying messages, a power source and at least one user interface for accepting an input.

11. A method of wireless communication between a central controller and mobile units within a facility via a plurality of base stations having adjustable transmission power distributed throughout the facility for wireless communication with said controller and said mobile units comprising configuring the base stations into a plurality of micro-cells each including at least two base stations by adjusting the wireless transmission power of said base stations such that at least one base station in each micro-cell is a member of another micro-cell, at least one base station is able to communicate with the central controller and all mobile units within a selected area of the facility are able to communicate with at least one base station.

12. A method as claimed in claim 11 wherein each micro-cell includes at least two base stations that are members of other micro-cells.

13. A method as claimed in claim 12 wherein each micro-cell includes from three to six base stations.

14. A method as claimed in claim 11 wherein the base stations periodically transmit a message including a unique identification code.

15. A method as claimed in claim 14 wherein said message includes a measure of the transmitting power of the base station.

16. A method as claimed in claim 11 wherein each base station maintains a list of signals received from other base stations.

17. A method as claimed in claim 11 wherein the base station transmission power is adjusted to provide minimal overlap of base stations between micro-cells.

18. A method as claimed in claim 11 wherein the base stations each have a known location and the micro-cells have a relatively small area compared to selected area of the facility.

19. A method for locating and messaging to mobile units in a facility including a method as claimed in claim 11.

20. A method as claimed in claim 19 wherein the mobile units include a transceiver for receiving and sending signals, a display device for displaying messages, a power source and at least one user interface for accepting an input.
